(19) United States
(12) Patent Application Publication
(10) Pub. No.: US 2023/0001677 A1
(43) Pub. Date: Jan. 5, 2023

(54) HEAT-RESISTANT SHRINKABLE ADHESIVE FILM

(71) Applicant: 3M INNOVATIVE PROPERTIES COMPANY, St. Paul, MN (US)

(72) Inventors: Tsuneharu Takeuchi, Kanagawa (JP); Yorinobu Takamatsu, Kanagawa (JP)

(21) Appl. No.: 17/787,831

(22) PCT Filed: Dec. 17, 2020
(86) PCT No.: PCT/IB2020/062146

§ 371 Date: Jun. 21, 2022

(30) Foreign Application Priority Data
Dec. 27, 2019 (JP) 2019-238553

(51) Int. Cl. B32B 27/30; B32B 7/12; B32B 37/10; B32B 37/06

(52) U.S. Cl. CPC B32B 27/308; B32B 7/12; B32B 37/1018; B32B 37/06; B32B 27/08

(57) ABSTRACT

Provided is a heat-resistant shrinkable adhesive film capable of reducing or preventing defects such as shrinkage when exposed to a high temperature even when bonded in a highly stretched state. A heat-resistant shrinkable adhesive film according to one embodiment of the present disclosure includes (A) an acid functional group-containing (meth)acrylic polymer having a glass transition temperature of about 25° C. or lower, and (B) an acid or base functional group-containing (meth)acrylic polymer having a glass transition temperature of about 50° C. or higher, the mixing ratio of the component (A) being larger than the mixing ratio of the component (B), and the adhesive film including an adhesive layer with a crosslinked structure derived from a metal coordination bond crosslinking agent and can be stretched to an area magnification of 4 times or more

### TECHNICAL FIELD

The present disclosure relates to a heat-resistant shrinkable adhesive film.

### BACKGROUND

In recent years, instead of painting, for example, various decorative films have been used in a wide range of fields such as automobile interior materials.

JP 2016-120642 A describes a film capable of coating an article having a three-dimensional shape by heating and stretching, the film including an outermost layer placed on the outermost surface, a polyurethane heat-bonding layer containing a thermoplastic polyurethane selected from the group consisting of polyester-based polyurethane and polycarbonate-based polyurethane, which is heat-bonded to an article during heat-stretching, the breaking strength of the polyurethane heat-bonding layer being 1 MPa or more at 135° C., the storage elastic modulus at 150° C. and a frequency of 1.0 Hz being from 5×10 Pa³ to 5×10⁵ Pa, and the loss coefficient tan δ being 0.1 or more.

JP 2018-016059 A describes a decorative film that can be used in vacuum compressed air molding and the like, the decorative film including a substrate layer, a bright layer having a concavo-convex surface on the substrate layer, which is separate from the substrate layer or integrated with the substrate layer, a transparent resin layer on or above the bright layer, and a translucent metallic layer with a substantially flat surface shape on or above the transparent resin layer, and the decorative film exhibiting flip-flop properties.

JP 2009-035588 A describes an adhesive film including a substrate and an adhesive layer on the substrate, the adhesive layer containing (A) a carboxylic group-containing (meth)acrylic polymer having a glass transition temperature (Tg) of 25° C. or lower, in which the ratio of the number of repeating units containing a carboxyl group to the total number of repeating units of the polymer is from 4.0 to 25% and (B) an amino group-containing (meth)acrylic polymer having a glass transition temperature (Tg) of 75° C. or higher, in which the ratio of the number of repeating units containing an amino group to the total number of repeating units of the polymer is from 3.5 to 15%, and the mixing ratio of the component (A) and the component (B) being from 62:38 to 75:25 by weight.

### SUMMARY

For example, a decorative film is generally attached to the surface of a support member via an adhesive layer. The support member is not limited to a support member having a flattened shape or a gently curved surface shape, and for example, may be a support member with a sharply bent curved surface. When a decorative film is applied to such a support member, the applied film is generally heated and bonded in a highly stretched state, particularly in a severe curved surface shape of the support member. As a result, the applied film, particularly the adhesive layer constituting the film, is subjected to a return stress to return to the original state. Therefore, for example, under high temperature conditions in summer, the applied film may shrink or peel off from an edge or the like, causing problems such as deterioration of design.

The present disclosure provides a heat-resistant shrinkable adhesive film capable of reducing or preventing defects such as shrinkage when exposed to a high temperature even when bonded in a highly stretched state.

### Solution to Problem

One embodiment of the present disclosure provides a heat-resistant shrinkable adhesive film that can be stretched to an area magnification of 4 times or more, including an adhesive layer containing (A) an acid functional group-containing (meth)acrylic polymer having a glass transition temperature of about 25° C. or lower, and (B) an acid or base functional group-containing (meth)acrylic polymer having a glass transition temperature of about 50° C. or higher, the mixing ratio of the component (A) being higher than that of the component (B), and the adhesive layer having a crosslinked structure derived from a metal coordination bond crosslinking agent.

Another embodiment of the present disclosure provides a method for producing an article including a step of forming an article by vacuum heat-pressing the heat-resistant shrinkable adhesive film on the surface of a support member, at least a portion of this heat-resistant shrinkable adhesive film being stretched to an area magnification of 4 times or more.

Another embodiment of the present disclosure provides an article in which the adhesive layer of the heat-resistant shrinkable adhesive film is disposed on the surface of a support member, at least a part of the heat-resistant shrinkable adhesive film being stretched to an area magnification of 4 times or more.

Another embodiment of the present disclosure provides a heat-resistant shrinkable adhesive composition including (A) an acid functional group-containing (meth)acrylic polymer having a glass transition temperature of about 25° C. or lower, and (B) an acid or base functional group-containing (meth)acrylic polymer having a glass transition temperature of about 50° C. or higher, and a metal coordination bond crosslinking agent, the mixing ratio of the component (A) being larger than the compounding ratio of the component (B).

### Advantageous Effects of Invention

The present disclosure provides a heat-resistant shrinkable adhesive film capable of reducing or preventing defects such as shrinkage when exposed to a high temperature even when bonded in a highly stretched state.

The above description will not be construed to mean that all embodiments of the present invention and all advantages of the present invention are disclosed.

### BRIEF DESCRIPTION OF THE DRAWINGS

FIG. 1 is a cross-sectional view of a heat-resistant shrinkable adhesive film according to an embodiment of the present disclosure.

FIG. 2 is a diagram schematically illustrating a step of applying a heat-resistant shrinkable adhesive film to a support member using a vacuum heat crimping device to form an article.

FIG. 3 is a schematic view of a test device for a heat shrinkage test.

FIG. 4 is a diagram for explaining the area elongation rate (stretched area magnification) of the heat-resistant shrinkable adhesive film after the heat shrinkage test.

### DETAILED DESCRIPTION

Although representative embodiments of the present invention will now be described in greater detail for the purpose of illustration with reference to the drawings, the present invention is not limited to these embodiments. As for the reference signs in the drawings, elements denoted by the similar reference signs in different drawings indicate similar or corresponding elements.

As used herein, “film” also includes an article referred to as a “sheet”.

In the present disclosure, for example, “on” as in “a decorative layer is disposed on a substrate” is intended to mean that the decorative layer is disposed directly on a top side of the substrate, or that the decorative layer is indirectly disposed on a top side of the substrate with another layer interposed between the decorative layer and the substrate.

In the present disclosure, for example, “below” as in “an adhesive layer disposed below a substrate” is intended to mean that the adhesive layer being disposed directly on a bottom side of the substrate, or the adhesive layer being indirectly disposed on a bottom side of the substrate with another layer interposed between the adhesive layer and the substrate.

In the present disclosure, “acid” and “base” in “acid functional group” and “base functional group” are not acids and bases as defined by Arenius, but are intended as so-called broadly defined acids and bases, that is, Bronsted and Lowry definitions, and Lewis's definition of acids and bases.

In the present disclosure, the term “substantially” refers to including variations caused by for instance manufacturing errors, and is intended to mean that approximately +/−20% variation is acceptable.

In the present disclosure, “transparent” means that the average transmittance in the visible light region (wavelength 400 nm to 700 nm) measured in accordance with JIS K 7375 is about 80% or more, preferably about 85% or more, or about 90% or more. An upper limit value of the average transmittance is not particularly limited, but for example, can be defined as approximately less than 100%, approximately 99% or less, or approximately 98% or less.

In the present disclosure, “translucent” means that an average transmittance in a visible light region (wavelength of from 400 nm to 700 nm) measured in accordance with JIS K 7375 is less than 80%, and may be desirably 75% or less, and is intended to mean that an underlying layer is not completely hidden.

In the present disclosure, “(meth)acrylic” means acrylic or methacrylic, and “(meth)acrylate” means acrylate or methacrylate.

With reference to the drawings, a heat-resistant shrinkable adhesive film containing an adhesive layer and which can be stretched to an area magnification of 4 times or more will be illustrated.

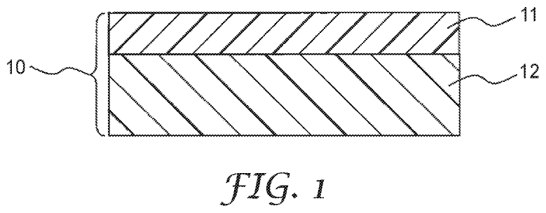

FIG. 1 is a cross-sectional view of a heat-resistant shrinkable adhesive film 10 according to an embodiment of the present disclosure. The heat-resistant shrinkable adhesive film 10 of FIG. 1 includes an adhesive layer 11 and a substrate 12. The substrate 12 is an optional constituent layer, and the heat-resistant shrinkable adhesive film of the present disclosure does not have to include such a layer.

To exemplify representative embodiments of the present disclosure, details of the structural components are described below with some of the reference signs being omitted.

The heat-resistant shrinkable adhesive film of the present disclosure may have a single-layer structure of an adhesive layer, or may have a laminated structure including an optional layer (for example, a substrate, a decorative layer, a bonding layer, and an outermost layer) described later.

The adhesive layer of the present disclosure includes: (A) an acid functional group-containing (meth)acrylic polymer having a glass transition temperature of about 25° C. or lower; and (B) an acid or base functional group-containing (meth)acrylic polymer having a glass transition temperature of about 50° C. or higher, the mixing ratio of the component (A) being larger than the mixing ratio of the component (B), and the adhesive layer having a crosslinked structure derived from a metal coordination bond crosslinking agent.

The (meth)acrylic polymer may be a polymer obtained from a (meth)acrylic monomer, or a copolymer in which a (meth)acrylic monomer and a monomer other than the (meth)acrylic monomer, for example, a vinyl unsaturated monomer, are arbitrarily combined.

Typical examples of the monoethylenically unsaturated monomer constituting the (meth)acrylic polymer include a monomer represented by the formula CH₂═CR^{a}COOR^{b} (wherein R^{a} is hydrogen or a methyl group, and R^{b} is a linear, branched, or cyclic alkyl group, phenyl group, alkoxyalkyl group, or phenoxyalkyl group). Examples of other monoethylenically unsaturated monomers include aromatic vinyl monomers such as styrene, α-methylstyrene, and vinyltoluene, and vinyl esters such as vinyl acetate. The monoethylenically unsaturated monomer may be used alone or in combination of two or more, depending on the purpose, in order to obtain a desired glass transition temperature, adhesiveness at room temperature, hot adhesiveness, and the like.

Examples of such monomers include alkyl (meth)acrylates such as methyl (meth)acrylate, ethyl (meth)acrylate, n-butyl (meth)acrylate, isobutyl (meth)acrylate, tertiary butyl (meth)acrylate, isoamyl (meth)acrylate, n-hexyl (meth)acrylate, cyclohexyl (meth)acrylate, 2-ethylhexyl (meth)acrylate, isooctyl (meth)acrylate, isononyl (meth)acrylate, isobornyl (meth)acrylate, dicyclopentanyl (meth)acrylate, decyl (meth)acrylate, and dodecyl (meth)acrylate; phenoxyalkyl (meth)acrylates such as phenoxyethyl (meth)acrylates; and alkoxyalkyl (meth)acrylates such as methoxypropyl (meth)acrylate and 2-methoxybutyl (meth)acrylate. Among these, alkyl (meth)acrylates having an alkyl group having 1 to 12 carbon atoms are preferable.

The component (A) of the present disclosure is an acid functional group-containing (meth)acrylic polymer having a glass transition temperature (which may be referred to as “Tg”) of about 25° C. or lower, and is a softer polymer than the polymer of the component (B).

The acid functional group-containing (meth)acrylic polymer having a glass transition temperature of about 25° C. or lower can be easily prepared, for example, by using a monomer having a glass transition temperature of the homopolymer of about 25° C. or lower as a main component. Examples of such a monomer include methyl acrylate, ethyl acrylate, n-butyl acrylate, isobutyl acrylate, isoamyl acrylate, 2-ethylhexyl (meth)acrylate, isooctyl (meth)acrylate, and dodecyl (meth)acrylate.

From the viewpoint of adhesiveness at room temperature, cohesive force at high temperature, and the like, Tg is preferably about 20° C. or lower, about 15° C. or lower, about 10° C. or lower, about 5° C. or lower, or about 0° C. or lower. The lower limit of Tg is not particularly limited, but can be defined as, for example, about −50° C. or higher, about −30° C. or higher, about −20° C. or higher, or about −10° C. or higher. Here, the glass transition temperature (° C.) of each polymer in the components (A) and (B) can be obtained from the following FOX equation, assuming that each polymer is copolymerized from n kinds of monomers:

$$\frac{1}{Tg + 273.15} = \text{?} \qquad Equation 1$$

$$\text{?} \text{indicates text missing or illegible when filed}$$

wherein, Tgᵢ represents a glass transition temperature (° C.) of a homopolymer of a component i; Xᵢ represents a mass fraction of a monomer of the component i added during polymerization; i is a natural number of 1 to n, and satisfies:

$$\text{?} = 1 \qquad Equation 2$$

$$\text{?} \text{indicates text missing or illegible when filed}$$

The (meth)acrylic polymer of the component (A) contains an acid functional group. The introduction of the acid functional group into the (meth)acrylic polymer can be carried out, for example, by copolymerizing an unsaturated monomer containing an acid functional group with the monoethylenically unsaturated monomer described above. The (meth)acrylic polymer of the component (A) only needs to contain an acid functional group, and may have a base functional group introduced by using the below-described unsaturated monomer containing a base functional group. However, from the viewpoint of heat resistance shrinkage, the (meth)acrylic polymer of the component (A) preferably does not contain a base functional group.

Examples of the unsaturated monomer containing an acid functional group include at least one monomer selected from an unsaturated monomer containing a carboxyl group, an unsaturated monomer containing a sulfone group, an unsaturated monomer containing a phosphone group, and a mixture thereof. Here, the “acid functional group” in the present disclosure is intended to be a functional group introduced into a (meth)acrylic polymer in a state in which the hydroxyl group of the carboxylic acid is unreacted, for example, acrylic acid, and does not include a functional group introduced into the (meth)acrylic polymer in a state where the hydroxyl group of the carboxylic acid is esterified, such as butyl acrylate.

Specifically, examples of the unsaturated monomer containing a carboxyl group include acrylic acid, methacrylic acid, itaconic acid, phthalic acid, crotonic acid, citraconic acid, maleic acid, oleic acid, β-carboxyethyl (meth)acrylate, and 2-(meth)acryloyloxyethyl succinic acid, 2-(meth)acryloyloxyethyl hexahydrophthalic acid, ω-carboxypolycaprolactone mono(meth)acrylate, and monohydroxyethyl phthalate (meth)acrylate, and examples of the unsaturated monomer containing a sulfone group include 2-sulfoethyl methacrylate, styrene sulfonic acid, and 2-acrylamide-2-methylpropane sulfonic acid, and examples of the unsaturated monomer containing a phosphone group include 2-(meth)acryloyloxyethyl acid phosphate and vinyl phosphonic acid. Among these, unsaturated monomers containing a carboxyl group are preferable, and acrylic acid and methacrylic acid are more preferable, from the viewpoint of adhesiveness at room temperature, hot adhesiveness, and the like. These monomers may be used alone or in combination of two or more thereof.

From the viewpoint of adhesiveness at room temperature, hot adhesiveness, and the like, it is advantageous that the acid functional group-containing (meth)acrylic polymer of the component (A) is prepared so that the content of the above-mentioned unsaturated monomer containing an acid functional group is about 1 mass % or more, about 2 mass % or more, or about 3 mass % or more, and about 30 mass % or less, about 20 mass % or less, about 15 mass % or less, or about 10 mass % or less with respect to the total amount of the monomer components. The proportion of unsaturated monomer containing an acid functional group may also be specified by the molar concentration, for example, about 1.5 mol % or more, about 3.5 mol % or more, or about 5.0 mol % or more, and about 50 mol % or less, about 35 mol % or less, about 25 mol % or less, or about 20 mol % or less.

The weight average molecular weight of the acid functional group-containing (meth)acrylic polymer of the component (A) is not particularly limited, but for example, from the viewpoint of cohesive force and the like, may be about 100,000 or more, about 200,000 or more, or about 300,000, and may be about 1,000,000 or less, about 800,000 or less, or about 600,000 or less. As used herein, “weight average molecular weight” means a weight average molecular weight in terms of polystyrene as measured by gel permeation chromatography (GPC).

The component (B) of the present disclosure is an acid or base functional group-containing (meth)acrylic polymer having a glass transition temperature of about 50° C. or higher, and is a polymer that is harder than the polymer of the component (A).

The acid or base functional group-containing (meth)acrylic polymer having a glass transition temperature of about 50° C. or higher can be easily prepared, for example, by using a monomer having a glass transition temperature of the homopolymer of about 50° C. or higher as a main component. Examples of such a monomer include methyl methacrylate, ethyl methacrylate, n-butyl methacrylate, isobutyl methacrylate, tert-butyl methacrylate, cyclohexyl methacrylate, isobornyl (meth)acrylate, and dicyclopentanyl (meth)acrylate.

From the viewpoint of heat shrinkage and the like, the Tg is preferably about 60° C. or higher, about 70° C. or higher, or about 80° C. or higher. The upper limit of Tg is not particularly limited, but may be defined as, for example, about 250° C. or lower, about 200° C. or lower, about 150° C. or lower, or about 120° C. or lower.

The (meth)acrylic polymer of the component (B) contains an acid functional group or a base functional group. The introduction of the base functional group into the (meth)acrylic polymer can be carried out by copolymerizing the unsaturated monomer containing the base functional group with the monoethylenically unsaturated monomer described above, as in the case of the means for introducing the acid functional group. Both an acid functional group and a base functional group may be introduced into the (meth)acrylic polymer of the component (B). However, from the viewpoint of heat-resistant shrinkage, the (meth)acrylic polymer of the component (B) preferably has either an acid functional group or a base functional group introduced therein, and more preferably has only a base functional group. Here, the “base functional group” in the present disclosure is intended to be a nitrogen-containing functional group.

As the acid functional group-containing unsaturated monomer that may be used in the introduction of the acid functional group into the (meth)acrylic polymer, the above-mentioned monomer may be similarly used.

As the base functional group-containing unsaturated monomer, for example, a nitrogen-containing monomer such as a monomer represented by the following formula (I) may be used:

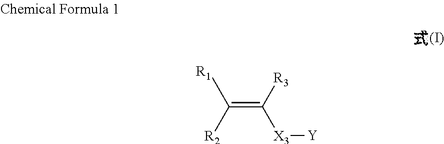

wherein,

a is 0 or 1,

R₁, R₂, and R₃ are independently selected from H—, CH₃—, and other alkyl groups,

X is selected from ester and amide groups,

Y is selected from an alkyl group, a nitrogen-containing aromatic group, and a group of the following formula, and

At least one group of X and Y is selected from groups containing a nitrogen atom;

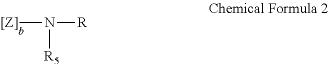

wherein,

Z is a divalent linking group (typically 1 to 5 carbon atoms),

b is 0 or 1, and

R₄ and R₅ are independently selected from hydrogen, alkyl, aryl, cycloalkyl, and allenyl groups.

R₄ and R₅ may form a heterocycle. In all embodiments, Y, R₁ and R₂ may contain a heteroatom such as O, S, or N. The above-described monomer of formula (I) represents an unsaturated monomer containing most of the useful base functional groups, but if it can be titrated with an acid, such other nitrogen-containing monomers may be used as unsaturated monomers containing base functional groups.

Specific examples of the unsaturated monomer containing a base functional group include at least one unsaturated monomer selected from unsaturated monomers containing an amino group, such as an unsaturated monomer having a nitrogen-containing heterocycle such as dialkylaminoalkyl (meth)acrylate, dialkylaminoalkyl (meth)acrylamide, and vinylimidazole.

Examples of the unsaturated monomer include N,N-dimethylaminopropylacrylamide (DMAPAAm), N,N-dimethylaminopropyl methacrylate (DMAPMAm), N,N-diethylaminopropyl methacrylate (DEAPMAm), N,N-dimethylaminoethyl ccrylate (DMAEA), N,N-diethylaminoethyl acrylate (DEAEA), N, N-dimethylaminopropyl acrylate (DMAPA), N, N-diethylaminopropyl acrylate (DEAPA), N,N-dimethylaminoethyl methacrylate (DMAEMA), N,N-diethylaminoethyl methacrylate (DEAEMA), N,N-dimethylaminoethylacrylamide (DMAEAm), N,N-dimethylaminoethylmethacrylate (DMAEMAm), N,N-diethylaminoethylacrylamide (DEAEAm), N,N-diethylaminoethylmethacrylamide (DEAEMAm), N,N-dimethylaminoethyl vinyl ether (DMAEVE), and N,N-diethylaminoethyl vinyl ether (DEAEVE). Examples of other useful unsaturated monomers include vinylpyridine, vinylimidazole, triaminofunctionalized styrene (for example, 4-(N,N-dimethylamino)-styrene(DMAS), 4-(N,N-diethylamino)-styrene (DEAS)), cyclic or acyclic ethylenically unsaturated amides (for example, N-vinylpyrrolidone, N-vinylcaprolactam, N-vinylholomamide, and (meth)acrylamide). These monomers may be used alone or in combination of two or more thereof.

From the viewpoint of heat shrinkage and the like, it is advantageous that the acid or base functional group-containing (meth)acrylic polymer of the component (B) is prepared so that the content of the unsaturated monomer containing the above-described acid functional group or base functional group is about 1 mass % or more, about 2 mass % or more, or about 3 mass % or more, and about 30 mass % or less, about 20 mass % or less, about 15 mass % or less, or about 10 mass % or less with respect to the total amount of the monomer components. The proportion of the unsaturated monomer containing an acid functional group or a base functional group may also be specified by the molar concentration, and may be, for example, about 1.5 mol % or more, about 3.5 mol % or more, or about 5.0 mol % or more, and about 50 mol % or less, about 35 mol % or less, about 25 mol % or less, or about 20 mol % or less with respect to the total amount of the monomer components.

The weight average molecular weight of the acid or base functional group-containing (meth)acrylic polymer of the component (B) is not particularly limited, but for example, from the viewpoint of cohesive force and the like, may be about 10,000 or more, about 20,000 or more, about 30,000 or more, or about 40,000 or more, and may be about 200,000 or less, about 170,000 or less, or about 150,000 or less.

From the viewpoint of adhesiveness at room temperature, hot adhesiveness, heat shrinkage, and the like, it is advantageous that the mixing ratio of the component (A) is larger than the mixing ratio of the component (B). The mixing ratio of the components (A) and (B) is, for example, preferably in the range of 65:35 to 80:20, more preferably in the range of 67:33 to 77:23, and particularly preferably in the range of 70:30 to 75:25 in terms of mass ratio.

The (meth)acrylic polymers of the components (A) and (B) described above may be produced, for example, by a radical polymerization method. As such a production method, known methods such as a solution polymerization method, a suspension polymerization method, an emulsion polymerization method, and a bulk polymerization method may be appropriately adopted.

Examples of the initiator that can be used in the production of the (meth)acrylic polymer include organic peroxides such as benzoyl peroxide, lauroyl peroxide, and bis(4-tertiary butylcyclohexyl) peroxydicarbonate; azo-based polymerization initiators such as 2,2′-azobisisobutyronitrile, 2,2′-azobis-2-methylbutyronitrile, 4,4′-azobis-4-cyanovaleric acid, 2,2′-azobis(2-methylpropionic acid)dimethyl, and azobis 2,4-dimethylvaleronitril (AVN). The used amount of the initiator is not particularly limited, and may be, for example, about 0.05 to about 5 parts by mass per 100 parts by mass of the monomer mixture.

The adhesive layer of the present disclosure may be prepared by using a heat-resistant shrinkable adhesive composition containing the (meth)acrylic polymer of the components (A) and (B) described above and a metal coordination bond crosslinking agent. The types, mixing ratios, and the like of the components (A) and (B) in the heat-resistant shrinkable adhesive composition are as described above.

Since the adhesive layer of the present disclosure is prepared using such a heat-resistant shrinkable adhesive composition, a crosslinked structure derived from a metal coordination bond crosslinking agent is formed in the adhesive layer. Such a crosslinked structure is a crosslinked structure by a coordination bond, and the polymers are considered to be loosely bonded to each other as compared with, for example, a crosslinked structure by a covalent bond when an epoxy-based crosslinking agent is used. To date, from the viewpoint of heat-resistant shrinkage performance, it has been considered that a strong crosslinked structure such as a covalent bond is preferable to a crosslinked structure formed by such a loose bond. This related-art technical idea regarding heat-resistant shrinkage performance may be applied when the stretching conditions of the adhesive film are loose. However, in the case of an adhesive film that is highly stretched to an area magnification of 4 times or more and bonded to a support member, stress remains in the adhesive layer in a strong crosslinked structure by a covalent bond. Therefore, when exposed to a high temperature, this residual stress functions like a return stress, and heat shrinkage cannot be suppressed. On the other hand, surprisingly, in the case of a crosslinked structure with a coordination bond looser than a covalent bond, it was possible to reduce or prevent heat shrinkage at high temperatures even with an adhesive film applied under such conditions. The principle is not clear, but likely as follows: in the case of a crosslinked structure by coordination bonds, the coordination bonds between the polymers are temporarily broken as the adhesive film is stretched, but at least at the stage when the stretching is completed, a reversible crosslinked structure is formed in which the coordination bond is re-formed between the polymers, and the return stress is less likely to occur as compared with the strong crosslinked structure by covalent bonds, and this makes it possible to reduce or prevent heat shrinkage at high temperatures.

The metal coordination bond crosslinking agent is not particularly limited as long as it has a metal atom and is capable of forming a coordination bond between the (meth)acrylic polymers of the components (A) and (B). Examples of the metal coordination bond crosslinking agent include tris (2,4-pentanedionato) aluminum (III), and titanium diisopropoxybis(acetylsetonate). Among these, tris(2,4-pentanedionato) aluminum (III) is preferable from the viewpoint of heat shrinkage and the like. These metal coordination bond crosslinking agents may be used alone or in combination of two or more thereof.

The blending amount of the metal coordination bond crosslinking agent may be about 0.15 parts by mass or more, about 0.17 parts by mass or more, or about 0.20 parts by mass or more with respect to a total of 100 parts by mass of the (meth)acrylic polymer (solid content) of the components (A) and (B), from the viewpoint of heat resistance, shrinkage, and the like The upper limit of the blending amount is not particularly limited, but may be, for example, about 3.0 parts by mass or less, about 2.5 parts by mass or less, about 2.0 parts by mass or less, or about 1.5 parts by mass or less.

In some embodiments, the heat-resistant shrinkable adhesive composition of the present disclosure and the adhesive layer prepared from the composition may include, as an optional component, for example, a filler, a reinforcing material, an antioxidant, a UV absorber, a light stabilizer, a thermal stabilizer, a dispersant, a plasticizer, a flow improving agent, a surfactant, a leveling agent, a silane coupling agent, a catalyst, a pigment, a dye, a thickener, and a solvent (for example, a water-based solvent and an organic solvent) within the range that does not inhibit the effects of the present disclosure.

The thickness of the adhesive layer of the heat-resistant shrinkable adhesive film of the present disclosure is not particularly limited, and may be, for example, about 5 micrometers or more, about 10 micrometers or more, or about 20 micrometers or more, and about 200 micrometers or less, about 100 micrometers or less, or about 80 micrometers or less. When the heat-resistant shrinkable adhesive film of the present disclosure has a single-layer structure of an adhesive layer, the thickness may be defined as the average value calculated by measuring the thickness of any part of the adhesive layer at least 5 times using a high-precision digital micrometer (MDH-25 MB, manufactured by Mitutoyo Corporation). When the heat-resistant shrinkable adhesive film of the present disclosure has a laminated structure, the thickness of each layer is measured by measuring the cross section in the thickness direction of the laminated structure using a scanning electron microscope, and may be defined as the average value of the thickness of any at least five points in the target layer in the laminated structure, for example, the adhesive layer.

In some embodiments, the heat-resistant shrinkable adhesive film of the present disclosure may further include, as an optional component, an additional layer such as an outermost layer, a substrate, a decorative layer, a bright layer, a bonding layer (which may be referred to as “primer layer” or the like) for joining constituent layers, and a release liner for protecting the adhesive layer within the range that will not impair the effects of the present disclosure. These additional layers can be employed alone or in combination of two or more.

In some embodiments, the outermost layer may be placed on the outermost surface of the heat-resistant shrinkable adhesive film. The outermost layer may function as a protective layer that protects other layers constituting the heat-resistant shrinkable adhesive film from external puncture, impact, and the like. The outermost layer may be a multilayered laminate, such as a multilayered extrusion laminate. The outermost layer may have a substantially smooth surface, or may have a concavo-convex shape such as an embossed pattern on the surface.

As the outermost layer, for example, various resins including (meth)acrylic resins including polymethyl methacrylate (PMMA); polyurethane; fluororesins such as ethylene/tetrafluoroethylene copolymers (ETFE), polyvinylidene fluoride (PVDF), and methyl methacrylate/vinylidene fluoride copolymers; silicone-based copolymers; polyvinyl chloride; polycarbonate; acrylonitrile-butadiene-styrene copolymers (ABS); polyolefin such as polyethylene and polypropylene; polyester such as polyethylene terephthalate (PET) and polyethylene naphthalate (PEN); copolymers such as ethylene/acrylic acid copolymers, ethylene/ethyl acrylate copolymers, and ethylene/vinyl acetate copolymers; and mixtures of these may be used. From the viewpoints of transparency, strength, and impact resistance, as the material of the outermost layer, a (meth)acrylic resin, polyurethane, a fluororesin, polyvinyl chloride, polyethylene terephthalate, an acrylonitrile-butadiene-styrene copolymer, and polycarbonate may be advantageously used.

The outermost layer may contain benzotriazole, a UV absorber such as Tinuvin (trademark) 400 (manufactured by BASF), or a hindered amine light stabilizer (HALS) such as Tinuvin (trademark) 292 (manufactured by BASF), as necessary. By using, for example, a UV absorber or a hindered amine light stabilizer, deterioration of a layer positioned under the outermost layer, such as color change, fading, and deterioration of the decorative layer, can be effectively prevented. The outermost layer may contain, for example, a hard coat material and a gloss-imparting agent, and may have an additional hard coat layer.

The outermost layer may be transparent, translucent, or opaque in visible range in its entirety or partially to provide the desired appearance (for example, matte appearance).

The thickness of the outermost layer may be, for example, about 1 micrometer or more, about 5 micrometers or more, or about 10 micrometers or more, and may be about 200 micrometers or less, about 100 micrometers or less, or about 50 micrometers or less.

In some embodiments, the heat-resistant shrinkable adhesive film of the present disclosure may include a substrate. The substrate may be used as, for example, a support of the adhesive layer. The surface of the substrate may be subjected to surface treatment, such as corona treatment or plasma treatment.

Examples of raw materials for the substrate include polyvinyl chloride resins, polyurethane resins, polyolefin resins, polyester resins, polycarbonate resins, polyimide resins, polyamide resins, (meth)acrylic resins, and fluororesins. These may be used alone or in combination of two or more of them.

The thickness of the substrate may be, for example, about 50 micrometers or more, about 80 micrometers or more, or about 100 micrometers or more. The upper limit of the thickness is not particularly limited but can be, for example, approximately 500 micrometers or less, approximately 300 micrometers or less, or approximately 200 micrometer or less, from the perspectives of followability and production cost, for example.

In the heat-resistant shrinkable adhesive film of the present disclosure, for example, a decorative layer may be disposed on or under a substrate. The decorative layer can be, for example, applied to an entire surface or a portion of the substrate.

Examples of the decorative layer include, but are not limited to: a color layer that exhibits a paint color, for example a light color such as white and yellow, or a dark color such as red, brown, green, blue, gray, and black; a pattern layer that imparts to an article a pattern, a logo, a design or the like such as a wood grain tone, a stone grain tone, a geometric pattern, and a leather pattern; a relief (embossed carving pattern) layer provided with an protruded and concavo-convex shape on a surface; and combinations thereof.

As a material of the color layer, for example, a material in which a pigment such as an inorganic pigment such as carbon black, yellow lead, yellow iron oxide, Bengala, or red iron oxide; a phthalocyanine pigment such as phthalocyanine blue or phthalocyanine green; and an organic pigment such as an azo lake pigment, an indigo pigment, a perinone pigment, a perylene pigment, a quinophthalone pigment, a dioxazine pigment, and a quinacridone pigment such as quinacridone red is dispersed in a binder resin such as a (meth)acrylic resin or a polyurethane resin can be used. However, the material of the color layer is not limited thereto.

Such a material may be used to form the color layer by, for example, a coating method such as gravure coating, roll coating, die coating, bar coating, and knife coating, or a printing method such as inkjet printing.

As a pattern layer, a pattern layer obtained by, for example, directly applying a pattern, a logo, a design, or other such patterns to the substrate or the like by using a printing method such as gravure direct printing, gravure offset printing, inkjet printing, laser printing, or screen printing may be adopted, or a film, a sheet, or the like having a pattern, a logo, a design, or the like formed by coating such as gravure coating, roll coating, die coating, bar coating, and knife coating, or by punching, etching, or the like may also be used. However, the pattern layer is not limited thereto. For example, a material similar to the material used in the color layer may be used as the material of the pattern layer.

As a relief layer, a thermoplastic resin film having a concavo-convex shape on a surface obtained by a conventionally known method such as embossing, scratching, laser machining, dry etching, or hot pressing may be used. The relief layer can also be formed by coating the release liner having a concavo-convex shape with a thermosetting or radiation curable resin such as a curable (meth)acrylic resin, curing by heating or radiation irradiation, and removing the release liner.

The thermoplastic resin, the thermosetting resin, and the radiation curable resin used in the relief layer are not particularly limited, and for example, a fluororesin, a polyester resin such as PET, and PEN, a (meth)acrylic resin, a polyolefin resin such as polyethylene, and polypropylene, a thermoplastic elastomer, a polycarbonate resin, a polyamide resin, an ABS resin, an acrylonitrile-styrene resin, a polystyrene resin, a vinyl chloride resin, and a polyurethane resin can be used. The relief layer may include at least one of the pigments used in the color layer.

The thickness of the decorative layer may be appropriately adjusted depending on, for example, required decorative properties and concealing properties and is not limited to a particular thickness, and may be, for example, about 1 micrometer or more, about 3 micrometers or more, or about 5 micrometers or more, and about 50 micrometers or less, about 40 micrometers or less, about 30 micrometers or less, about 20 micrometers or less, or about 15 micrometers or less.

The brightening layer is not limited to the following, but may be a layer that includes a metal selected from aluminum, nickel, gold, silver, copper, platinum, chromium, iron, tin, indium, titanium, lead, zinc, and germanium, or an alloy or a compound thereof, and that is formed by vacuum deposition, sputtering, ion plating, plating, or the like on an entire surface or a part of the substrate or the decorative layer. The thickness of the brightening layer may be selected arbitrarily according to the required decorative property, brightness and the like.

In the present disclosure, a heat-resistant shrinkable adhesive film colored by blending a pigment or the like, or a heat-resistant shrinkage adhesive film provided with a decorative layer and/or a bright layer may be referred to as a decorative film.

In some embodiments, the heat-resistant shrinkable adhesive film of the present disclosure may be provided with a bonding layer for bonding each of the constituent layers. As a bonding layer, for example, a commonly used (meth)acrylic-based, polyolefin-based, polyurethane-based, polyester-based, or rubber-based solvent type, emulsion type, pressure sensitive type, heat sensitive type, thermosetting type, or UV curing type adhesive may be used. The bonding layer may be applied by a known coating method or the like.

The thickness of the bonding layer may be, for example, approximately 0.05 micrometers or greater, approximately 0.5 micrometers or greater, or approximately 5 micrometers or greater, and may be approximately 100 micrometers or less, approximately 50 micrometers or less, approximately 20 micrometers or less, or approximately 10 micrometers or less.

The outermost layer, the substrate, the decorative layer, and the bonding may include, as an optional component, for example, a filler, a reinforcing material, an antioxidant, a UV absorber, a light stabilizer, a thermal stabilizer, a tackifier, a dispersant, a plasticizer, a flow improving agent, a surfactant, a leveling agent, a silane coupling agent, a catalyst, a pigment, and a dye, within the range that does not inhibit the effects of the present disclosure and decorative properties.

In some embodiments, any suitable release liner may be used to protect the adhesive layer. Examples of a typical release liner include those prepared from paper (e.g., kraft paper), and from polymeric materials (e.g., polyolefin such as polyethylene or polypropylene, ethylene vinyl acetate, polyurethane, polyethylene terephthalate, and other such polyester). On the release liner, a layer of a release agent such as a silicone-containing material or a fluorocarbon-containing material may be applied as necessary.

The thickness of the release liner may be, for example, approximately 5 micrometers or greater, approximately 15 micrometers or greater, or approximately 25 micrometers or greater, and may be approximately 300 micrometers or less, approximately 200 micrometers or less, or approximately 150 micrometers or less. The thickness of the release liner can be defined as an average value calculated by, after the release liner is removed from the adhesive layer, measuring the thickness of selected portion of the release liner for at least five times by using High-Accuracy Digimatic Micrometer (MDH-25 MB, available from Mitutoyo Corporation).

The heat-resistant shrinkable adhesive film of the present disclosure may be appropriately prepared by a single or a combination of a plurality of publicly known methods, such as printing methods including gravure direct printing, gravure offset printing, inkjet printing, and screen printing, coating methods such as gravure coating, roll coating, die coating, bar coating, knife coating, and extrusion coating, lamination methods, and transfer methods.

As an example, the following production method is described below; however, the production method of the heat-resistant shrinkable adhesive film is not limited to this. For example, in the case of the heat-resistant shrinkable adhesive film having the above-described release liner, adhesive layer, substrate, decorative layer, and surface protective layer in this order (it can be referred to as “decorative film” because it includes the decorative layer), a heat-resistant shrinkable adhesive composition is coated on the substrate, a drying step and a crosslinking step are applied as necessary, and then a release liner is attached to the adhesive layer to prepare a laminate A. A decorative composition containing a pigment and a binder resin is coated on a surface of the substrate of the laminate A, and, as necessary, a drying step and a curing step are applied to prepare the decorative layer. Then, a surface-protective composition containing a hard coating agent or the like is coated on the decorative layer, and as necessary, a drying step and a curing step are applied to form a surface-protective layer, thus preparing a heat-resistant shrinkable adhesive film (decorative film). The formation of the surface protective layer may be implemented by molding the surface protective composition in the form of a film or sheet, and then bonding the film or sheet.

The heat-resistant shrinkable adhesive film of the present disclosure has excellent adhesiveness, and has heat-resistant shrinkage performance capable of reducing or preventing defects such as shrinkage when exposed to a high temperature even when bonded in a highly stretched state.

The adhesiveness of the heat-resistant shrinkable adhesive film of the present disclosure can be evaluated by, for example, an initial adhesive force test described later and a hot adhesive force test in an atmosphere of 110° C.

In some embodiments, the heat-resistant shrinkable adhesive films of the present disclosure achieve an initial adhesive force of about 2.0 N/25 cm or more, about 2.5 N/25 cm or more, or about 5.0 N/25 cm or more. The upper limit of the initial adhesive force is not particularly limited, but can be defined as, for example, about 100 N/25 cm or less, about 80 N/25 cm or less, or about 60 N/25 cm or less.

In some embodiments, the heat-resistant shrinkable adhesive films of the present disclosure can achieve a hot adhesive force of about 2.0 N/25 cm or more, about 2.5 N/25 cm or more, or about 5.0 N/25 cm or more. The upper limit of the hot adhesive force is not particularly limited, but can be defined as, for example, about 50 N/25 cm or less, about 40 N/25 cm or less, or about 30 N/25 cm or less.

The heat-resistant shrinkage of the heat-resistant shrinkable adhesive film of the present disclosure can be evaluated by, for example, a heat-shrinking test described later.

In some embodiments, the heat-resistant shrinkable adhesive film of the present disclosure can achieve a base material exposed length of about 1.0 mm or less, about 0.8 mm or less, about 0.6 mm or less, or about 0.5 mm or less. The lower limit of the base material exposed length is not particularly limited, but can be defined as, for example, about 0 mm or more.

In some embodiments, the heat-resistant shrinkable adhesive films of the present disclosure have an adhesive-exposed length after a heat shrinkage test of about 1.0 mm or less, about 0.8 mm or less, about 0.7 mm or less, about 0.6 mm or less, or about 0.5 mm or less. The lower limit of the adhesive exposed length is not particularly limited, but can be defined as, for example, about 0 mm or more or more than about 0 mm.

In some embodiments, the heat-resistant shrinkable adhesive film of the present disclosure can achieve a deformed portion length after a heat shrinkage test of about 2.0 mm or less, about 1.9 mm or less, about 1.7 mm or less, or about 1.5 mm. The lower limit of the deformed portion length is not particularly limited, but can be defined as, for example, about 0 mm or more, about 0.1 mm or more, or about 0.2 mm or more.

In some embodiments, the heat-resistant shrinkable adhesive film of the present disclosure can suppress the generation of air pools having a diameter of 0.3 mm or more between the film and the support member after the heat shrinkage test.

In some embodiments, the heat-resistant shrinkable adhesive film of the present disclosure can exhibit good heat-resistant shrinkage even when the initial adhesive strength and/or the hot adhesive strength is low.

One embodiment of the present disclosure provides an article in which the adhesive layer of the heat-resistant shrinkable adhesive film described above is disposed on the surface of a support member. The heat-resistant shrinkable adhesive film of the present disclosure has excellent elongation properties and thus can be applied not only to a flat plate-shaped support member but also to a curved surface-shaped or three-dimensional shaped support member, so that it can be used for various purposes. Since the heat-resistant shrinkable adhesive film of the present disclosure can reduce or prevent defects such as shrinkage when exposed to high temperatures in summer even if, for example, it is attached to a curved or three-dimensional support member in a highly stretched state, it can also be used in applications exposed to such high temperatures. In the present disclosure, “high temperature” can be intended to be a temperature exceeding room temperature, and for example, a temperature of about 50° C. or higher, about 60° C. or higher, or about 70° C. or higher

The material for the support member is not particularly limited, and, for example, a resin material, an inorganic material such as glass, a metal material, and a ligneous material can be used. As the resin material, for example, polycarbonate, acrylonitrile-butadiene-styrene copolymer, or a mixture thereof can be used.

In some embodiments, the heat-resistant shrinkable adhesive film of the present disclosure can be used, for example, for interior or exterior components for decoration, such as interior or exterior components of vehicles including cars, trains, aircraft, and ships (for example, roof member, pillar member, door trim member, instrument panel member, front member such as bonnet, bumper member, fender member, side sill member, and interior panel member), and building members (for example, window glass, doors, window frames, roof component such as tiles, outer wall components, and wall papers). In addition, the heat-resistant shrinkable adhesive film of the present disclosure can be used for electronic products such as personal computers, smartphones, mobile phones, refrigerators, and air conditioning devices; stationery; furniture; desks; and various containers such as cans, and the like.

The method of applying the heat-resistant shrinkable adhesive film of the present disclosure to a support member (adherend) constituting an article is not particularly limited, and a known method may appropriately be used. Examples of such a method include bonding by hand, injection molding methods such as an insert injection molding method, in-mold molding method, over-mold molding method, two color injection molding method, core-back injection molding method, and sandwich injection molding method, lamination method, and three-dimensional overlay method (TOM).

Since the related-art adhesive film or decorative film does not have the heat-resistant shrinkage performance of the present disclosure, generally, a primer layer is applied between an adhesive layer of an adhesive film or a decorative film and a support member to ensure heat-resistant shrinkage performance. However, since the heat-resistant shrinkable adhesive film of the present disclosure can exhibit heat-resistant shrinkage performance without such a primer layer, it contributes to reduction of the primer application process, that is, reduction of production cost. However, the article of the present disclosure does not exclude the application of the primer layer between the heat-resistant shrinkable adhesive film and the support member.

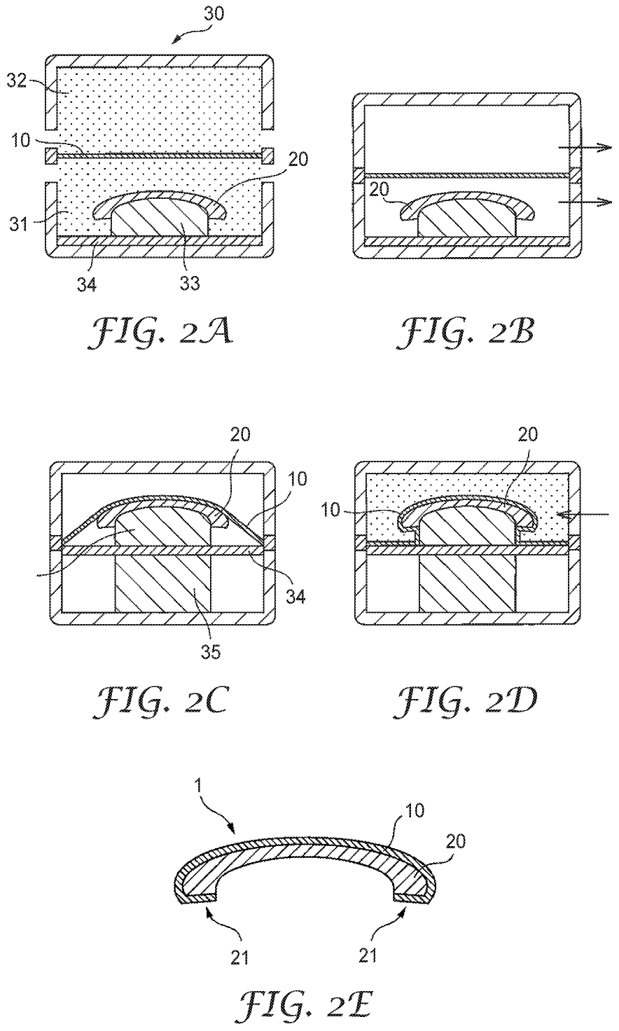

Hereinafter, a method for applying the heat-resistant shrinkable adhesive film to the support member using TOM will be exemplified by reference to FIG. 2.

As shown in FIG. 2A, an exemplary vacuum heat crimping device 30 has a first vacuum chamber 31 and a second vacuum chamber 32 at the top and bottom, respectively, and has a jig for setting a heat-resistant shrinkable adhesive film 10 to be attached to a support member 20 which is an adherend between the upper and lower vacuum chambers. In addition, in the lower first vacuum chamber 31, a partition plate 34 and a pedestal 33 are installed on an elevating table 35 (not shown) that can be moved up and down, and a support member 20 such as a three-dimensional object is set on this pedestal 33. As such a vacuum heat crimping device, a commercially available device, for example, a double-sided vacuum forming machine (manufactured by Fu-se Vacuum Forming Co. Ltd.) may be used.

As shown in FIG. 2A, first, in a state where the first vacuum chamber 31 and the second vacuum chamber 32 of the vacuum heat crimping device 30 are released to atmospheric pressure, the heat-resistant shrinkable adhesive film 10 is set between the upper and lower vacuum chambers. The support member 20 is set on the pedestal 33 in the first vacuum chamber 31.

Next, as shown in FIG. 2B, the first vacuum chamber 31 and the second vacuum chamber 32 are closed and depressurized, and the inside of each chamber is evacuated (when the atmospheric pressure is 1 atm, for example, about 0 atm). The film is then heated or at the same time as vacuuming.

Next, as shown in FIG. 2C, the elevating table 35 is raised to push the support member 20 up to the second vacuum chamber 32. The heating may be performed by, for example, a lamp heater incorporated in the ceiling of the second vacuum chamber 32. The heating temperature can generally be about 50° C. or higher and about 180° C. or lower, preferably about 130° C. or higher and about 160° C. or lower. The degree of vacuum in the decompressed atmosphere may be about 0.10 atm or less, about 0.05 atm or less, or about 0.01 or less atm or less, assuming that the atmospheric pressure is 1 atm.

The heated heat-resistant shrinkable adhesive film 10 is pressed against the surface of the support member 20 and stretched. After that or at the same time as stretching, as shown in FIG. 2D, the inside of the second vacuum chamber 32 is pressurized to an appropriate pressure (for example, about 1 atm to about 3 atm). Due to the pressure difference, the heat-resistant shrinkable adhesive film 10 adheres to the exposed surface of the support member 20 and is stretched following the three-dimensional shape of the exposed surface, thus forming a coating that adheres to the surface of the support member. At least a portion of the heat-resistant shrinkable adhesive film may be, for example, stretched at an area magnification of about 4 times or more, about 4.5 times or more, or about 5 times or more when the film is stretched following the three-dimensional shape of the support member. After depressurizing and heating in the state of FIG. 2B, the inside of the second vacuum chamber 32 can be pressurized as it is, thereby covering the exposed surface of the support member 20 with the heat-resistant shrinkable adhesive film 10.

After that, the upper and lower first vacuum chambers 31 and the second vacuum chamber 32 are opened to the atmospheric pressure again, and the support member 20 coated with the heat-resistant shrinkable adhesive film 10 is taken out. As shown in FIG. 2E, the edge of the heat-resistant shrinkable adhesive film 10 in close contact with the surface of the support member 20 is trimmed to complete the TOM step. In this way, it is possible to obtain an article 1 having a good roll-in coating in which the heat-resistant shrinkable adhesive film 10 wraps around to the back surface portion 21 at the end portion of the support member 20 and covers the exposed surface cleanly.

The heat-resistant shrinkable adhesive film of the present disclosure can reduce or prevent defects such as shrinkage when exposed to a high temperature even when the heat-resistant adhesive film is bonded in a highly stretched state. Therefore, the maximum area elongation rate of the heat-resistant shrinkable adhesive film after molding can be about 400% or more, about 450% or more, or about 500% or more. The upper limit of the maximum area elongation rate is not particularly limited, and may be about 1000% or less, about 800% or less, or about 600% or less. Here, for example, 400% of the maximum area elongation rate corresponds to 4 times the stretched area magnification.

The area elongation rate is defined as follows: the area elongation rate (%)=(B−A)/A (A: the area of the part with the heat-resistant shrinkable adhesive film before molding, B: the area of the heat-resistant shrinkable adhesive film corresponding to A after molding). For example, when the area of a portion of the heat-resistant shrinkable adhesive film is 100 cm² before molding and the portion is 250 cm² on the surface of the article after molding, the area elongation rate is 150%. The maximum area elongation rate refers to the value of the portion having the highest area elongation rate among all the heat-resistant shrinkable adhesive films on the surface of the article.

For example, when a flat film is attached to a support member having a three-dimensional shape by TOM, the portion where the film first hits the support member is hardly stretched, and the area elongation rate is almost 0%, while the area elongation rate varies greatly depending on the location, such that the end portion to be attached lastly is greatly stretched and the area elongation rate becomes 400% or more. Whether or not a defect such as non-following to the support member or tearing of the film occurs at the portion where the film is most stretched determines the success or failure of molding. Therefore, rather than the average area elongation rate of the entire article, the area elongation of the most stretched portion, that is, the maximum area elongation, is a substantial index of acceptance or rejection of the article.

The maximum area elongation rate can be confirmed, for example, by printing 1 mm square on the entire surface of the heat-resistant shrinkable adhesive film before molding and measuring the area change after molding, or by measuring the thickness of the heat-resistant shrinkable adhesive film before and after molding.

### EXAMPLES

Specific embodiments of the present disclosure will be exemplified in the following examples, but the present invention is not limited to these embodiments. All parts and percentages are based on mass unless otherwise specified.

The materials used in the present examples are shown in Table 1.

TABLE 1

| [Name or Title] | Description |
|---|---|
| Decorative bonding film | Laminated film composed of an alloyed fluororesin-containing layer of polyvinylidene |
| | fluoride (PVDF) and polymethylmethacrylate (PMMA) with a thickness of about 30 μm, |
| | an acrylic layer with a thickness of about 75 μm, |
| | a polyurethane and phenoxy resin-containing layer with a thicknes of about 1 μm, and |
| | a polyester layer with a thickness of about 50 μm. |
| Teijin (trademark) Tetron | Polyester film (manufactured by Teijin Film Solutions Limited) |
| (trademark) G2 Film | |
| Resamine (trademark) D6260 | Water-based polyurethane resin, solid content: 30 mass % (manufactured by Dainichiseika |
| | Color & Chemicals Mfg. Co., Ltd.) |
| Low Tg Polymer A | Acid functional group-containing acrylic polymer composed of 94 mass % of n-butyl |
| | acrylate (BA) and 6 mass % of acrylic acid (AA), Tg: −49° C. |
| Low Tg Polymer B | Acid functional group-containing acrylic polymer composed of 90 mass % of n-butyl |
| | acrylate (BA) and 10 mass % of acrylic acid (AA), Tg: −45° C. |
| Low Tg polymer D | Base functional group-containing acrylic polymer composed of 88 mass % n-butyl acrylate |
| | (BA) and 12 mass % 2-(dimethylamino) ethyl methacrylate (DMAEMA), Tg: −45° C. |
| Low Tg Polymer E | Acrylic polymer containing acid functional group and base functional group composed of |
| | 86 mass % of n-butyl acrylate (BA), 12 mass % of 2-(dimethylamino) ethyl methacrylate |
| | (DMAEMA), and 2 mass % acrylic acid (AA), Tg: −43° C. |
| Low Tg Polymer F | Acid functional group-containing acrylic polymer composed of 5 mass % phenoxyethyl |
| | acrylate (PEA), 90 mass % of n-butyl acrylate (BA) and 5 mass % of acrylic acid (AA), |
| | Tg: −49° C. |
| High Tg Polymer A | A base functional group-containing methacrylic polymer composed of 60 mass % of |
| | methyl methacrylate (MMA), 34 mass % of n-butyl methacrylate (BMA) and 6 mass % of |
| High Tg Polymer B | 2-(dimethylamino) ethyl methacrylate (DMAEMA), Tg: +69° C. |
| | Acid functional group-containing methacrylic polymer composed of 95 mass % isobutyl |
| | methacrylate (IBMA) and 5 mass % methacrylic acid (MAA), Tg: +54° C. |
| High Tg Polymer C | Base functional group-containing methacrylic polymer composed of 40 mass % of methyl |
| | methacrylate (MMA), 54 mass % of n-butyl methacrylate (BMA) and 6 mass % of |
| | methacrylic acid (MMA), Tg: +58° C. |
| High Tg polymer D | Acid functional group-containing methacrylic polymer composed of 94 mass % isobutyl |
| | methacrylate (IBMA) and 6 mass % methacrylic acid (MAA), Tg: +55° C. |
| Epoxy crosslinking agent | Epoxy resin crosslinking agent solution, solid content 5 mass % |
| Metal coordination bond | Tris(2,4-pentanedionato)aluminum (III), solid content 5 mass % |
| crosslinking agent A | |
| Metal coordination bond | Titanium diisopropoxybis(acetylsetonate), solid content 75 mass % |
| crosslinking agent B | |
| Negative catalyst | Acetylacetone |
| Pigment | Titanium oxide white pigment with an average particle size of 0.25 μm |
| Primer | Isocyanate-based solution |

### Preparation of Decorative Substrate Film

A 50 micrometer thick Teijin (trademark) Tetron (trademark) G2 film was coated with Resamine (trademark) D6260, allowed to stand in an oven at 100° C. for 10 minutes, followed by in an oven at 160° C. for 10 minutes to prepare a polyurethane layer having a thickness of about 20 micrometers. On this polyurethane layer, a tin vapor deposition layer having a thickness of about 430 Å was formed at a rate of 5 Å/sec using a vacuum vapor deposition device (EX-400, manufactured by ULVAC Inc.) capable of irradiating a tin vapor deposition source with an electron beam, thus preparing a tin-deposited film.

The polyester layer was removed from the decorative bonding film, the tin-deposited surface of the tin-deposited film was superposed on it, the film was placed in a heated laminator equipped with a laminator roll at 100° C., and Teijin (trademark) Tetron (trademark) G2 film removed, thus preparing a decorative substrate film.

### Preparation of Adhesive Film

### Example 1

After mixing 70 parts by mass of low Tg polymer A and 30 parts by mass of high Tg polymer A, 0.71 parts by mass of the metal coordination bond crosslinking agent A was mixed based on a total of 100 parts by mass of the polymer (solid content). Then, 1.18 parts by mass of an antioxidant and 5.89 parts by mass of a pigment were added to prepare an adhesive composition.

The adhesive composition was coated on a 50 micrometer thick polyester release liner (3M) and allowed to stand in an oven at 80° C. for 5 minutes, followed by an oven at 120° C. for 5 minutes, thus preparing an adhesive layer with a thickness of about 40 micrometers. The obtained adhesive layer and the polyurethane layer of the decorative substrate film were put into a heated laminator provided with a laminator roll at 60° C. so as to overlap each other, and an adhesive film was prepared.

### Examples 2 to 19 and Comparative Examples 1 to 11

Each of the adhesive films of Examples 2 to 19 and Comparative Examples 1 to 11 was prepared in the same manner as in Example 1, except that the materials constituting the adhesive composition and their mixing ratios were changed as shown in Table 2, and, in Examples 17 to 19, a negative catalyst was added to the adhesive composition (2% in Example 17, 19% in Example 18, and 18% in Example 19 with respect to the total mass of the solution).

### Physical Property Evaluation Test

Properties of the adhesive film were evaluated by using the following method. Here, the primer layer was applied using TW I-350 only to the substrate of Example 2.

### Adhesive Strength Test

A 3 mm thick, substantially flat substrate (Excelloy (trademark) CK43, manufactured by Techno Polymer Co., Ltd) composed of an adhesive film and a mixture of polycarbonate and an acrylonitrile-butadiene-styrene copolymer was placed on a three-dimensional coating molding device (manufactured by Fu-se Vacuum Forming Co. Ltd.), bonded under the following conditions, and cured for 12 hours or more to prepare a test sample:

Set temperature: 135° C.

Film temperature: 163° C.

Area elongation rate: 100%

The test sample was attached to a Tensilon tensile tester (manufactured by Orientec Co., Ltd.), and the peeling adhesive strength of 180 degrees was measured under the condition of a peeling speed of 200 mm/min in an environment of 25° C. or 110° C. The results are shown in Table 2. In Table 2, the adhesive force at 25° C. is referred to as the initial adhesive force, and the adhesive force at 110° C. is referred to as the hot adhesive force.

### Heat Shrinkage Test

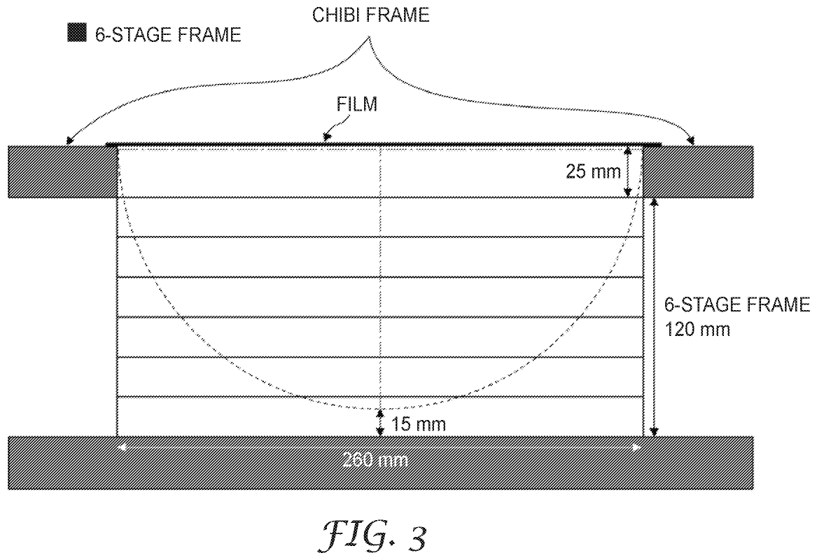

As shown in FIG. 3, a 6-stage frame having a height of 120 mm that can be evacuated was placed on a substantially flat substrate (Excelloy (trademark) CK43, manufactured by Techno Polymer Co., Ltd.) having a thickness of 3 mm, then a 25-mm thick frame (Chibi frame) was disposed on the frame to prepare a heat shrinkage test device. After attaching the adhesive film so as to cover the Chibi frame of this device, the device was placed in the three-dimensional coating molding device and heated so that the set temperature was 135° C. and the film temperature was 163° C. When the film hung down from the substrate at a position of about 15 mm, a vacuum was drawn from the left and right directions of the 6-stage frame, and the adhesive film was stretched and attached to the substrate to prepare a test sample for a heat shrinkage test.

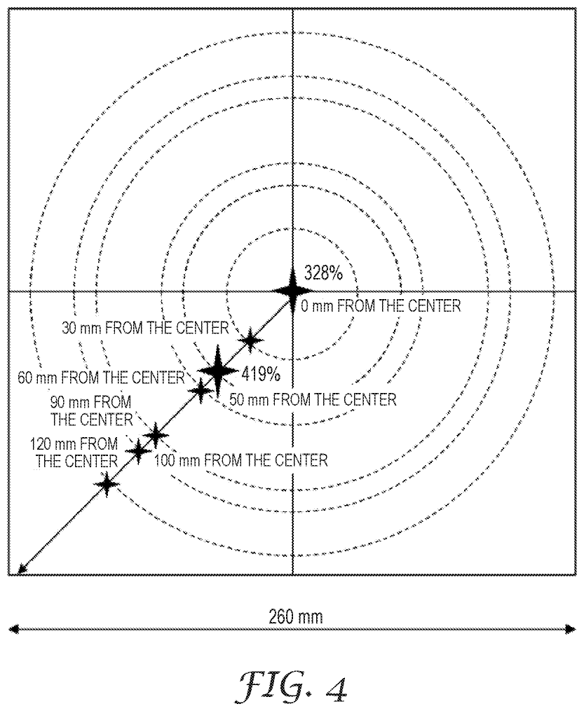

The concentric broken line portion shown in FIG. 4 at a distance of about 50 mm from the center is a region exhibiting an area elongation rate of about 400% in the adhesive film. The relationship between the distance from the center and the area elongation rate can be determined by, for example, drawing concentric lines on the adhesive film, applying it to the test device described above, and examining how much the concentric lines are stretched.

A cut was made in a concentric part about 50 mm away from the center of the test sample with a cutter, and the sample was allowed to stand in an oven at 110° C. for 24 hours. After that, the cut part of the test sample was visually observed, the base-material exposed length, the adhesive exposed length, and the deformed portion length after the heat shrinkage test were measured, and the presence or absence of air accumulation was confirmed. The results are shown in Table 2. Here, the “base-material exposed length” is intended to be the average length at any five points from the cut portion to the portion where the base material of the substrate is exposed, the “adhesive exposed length” is intended to be the average length at any five points where the adhesive is exposed from the film and adheres to the substrate, and the “deformed portion length” is intended to be the distance from the cut portion to the deformed portion due to the loss of flatness of the film, and includes the base material exposed length and the adhesive exposed length. In Table 2, “base-material exposed length” is abbreviated as “base-material exposed length”, “adhesive-exposed length” is abbreviated as “adhesive-exposed length”, and “deformed portion length” is abbreviated as “deformed portion length”.

TABLE 2

| | | | | | Mixing ratio | | |
|---|---|---|---|---|---|---|---|
| | | | | | between | Crosslinking agent | |
| | Low Tg component | | High Tg component | | low Tg:high Tg | | Mixing ratio |
| | Name | Composition | Name | Composition | component | Name | (mass %) |
| Comparative | Low Tg | BA/AA | High Tg | MMA/BMA/DMAEMA | 70:30 | Epoxy crossiinkmg agent | 0.10 |
| Example 1 | Polymer A | | Polymer A | | | | |
| Example 1 | Low Tg | BA/AA | High Tg | MMA/BMA/DMAEMA | 70:30 | Metal coordination bond | 0.71 |
| | Polymer A | | Polymer A | | | crosslinking agent A | |
| Example 2 | Low Tg | BA/AA | High Tg | MMA/BMA/DMAEMA | 70:30 | Metal coordination bond | 0.71 |
| (with primer | Polymer A | | Polymer A | | | crosslinking agent A | |
| layer) | | | | | | | |
| Example 3 | Low Tg | BA/AA | High Tg | MMA/BMA/DMAEMA | 75:25 | Metal coordination bond | 0.71 |
| | Polymer A | | Polymer A | | | crosslinking agent A | |
| Example 4 | Low Tg | BA/AA | High Tg | IBMA/MAA | 75:25 | Metal coordination bond | 0.60 |
| | Polymer B | | Polymer B | | | crosslinking agent A | |
| Example 5 | Low Tg | BA/AA | High Tg | IBMA/MAA | 75:25 | Metal coordination bond | 1.00 |
| | Polymer B | | Polymer B | | | crosslinking agent A | |
| Example 6 | Low Tg | BA/AA | High Tg | IBMA/MAA | 75:25 | Metal coordination bond | 0.80 |
| | Polymer B | | Polymer B | | | crosslinking agent A | |
| Example 7 | Low Tg | BA/AA | High Tg | IBMA/MAA | 75:25 | Metal coordination bond | 0.60 |
| | Polymer B | | Polymer B | | | crosslinking agent A | |
| Example 8 | Low Tg | BA/DMAAm/AA | High Tg | MMA/BMA/MAA | 75:25 | Metal coordination bond | 0.50 |
| | Polymer C | | Polymer C | | | crosslinking agent A | |
| Comparative | Low Tg | BA/DMAEMA | High Tg | MMA/BMA/MAA | 70:30 | Epoxy crosslinking agent | 0.05 |
| Example 2 | polymer D | | Polymer C | | | | |
| Comparative | Low Tg | BA/DMAEMA | High Tg | MMA/BMA/MAA | 70:30 | Epoxy crosslinking agent | 1.20 |
| Example 3 | polymer D | | Polymer C | | | | |
| Comparative | Low Tg | BA/DMAEMA | High Tg | MMA/BMA/MAA | 70:30 | Metal coordination bond | 1.00 |
| Example 4 | polymer D | | Polymer C | | | crosslinking agent A | |
| Comparative | Low Tg | BA/DMAEMA/AA | High Tg | MMA/BMA/MAA | 70:30 | Epoxy crosslinking agent | 0.10 |
| Example 5 | polymer E | | Polymer C | | | | |
| Example 9 | Low Tg | BA/DMAEMA/AA | High Tg | MMA/BMA/MAA | 70:30 | Metal coordination bond | 1.20 |
| | polymer E | | Polymer C | | | crosslinking agent A | |
| Comparative | Low Tg | BA/DMAEMA | High Tg | MMA/BMA/DMAEMA | 70:30 | Epoxy crosslinking agent | 0.05 |
| Example 6 | polymer D | | Polymer A | | | | |
| Comparative | Low Tg | BA/DMAEMA | High Tg | MMA/BMA/DMAEMA | 70:30 | Metal coordination bond | 1.20 |
| Example 7 | polymer D | | Polymer A | | | crosslinking agent A | |
| Example 10 | Low Tg | PEA/BA/AA | High Tg | MMA/BMA/DMAEMA | 70:30 | Metal coordination bond | 0.71 |
| | Polymer F | | Polymer A | | | crosslinking agent A | |
| Example 11 | Low Tg | BA/AA | High Tg | IBMA/MAA | 70:30 | Metal coordination bond | 1.34 |
| | Polymer A | | polymer D | | | crosslinking agent A | |
| Example 12 | Low Tg | PEA/BA/AA | High Tg | MMA/BMA/DMAEMA | 75:25 | Metal coordination bond | 0.71 |
| | Polymer F | | Polymer A | | | crosslinking agent A | |
| Comparative | Low Tg | BA/AA | High Tg | MMA/BMA/DMAEMA | 75:25 | Epoxy crosslinking agent | 0.10 |
| Example 8 | Polymer A | | Polymer A | | | | |
| Comparative | Low Tg | BA/AA | High Tg | MMA/BMA/DMAEMA | 70:30 | Epoxy crosslinking agent | 0.05 |
| Example 9 | Polymer A | | Polymer A | | | | |
| Comparative | LowTg | BA/AA | High Tg | MMA/BMA/DMAEMA | 70:30 | Epoxy crosslinking agent | 0.033 |
| Example 10 | Polymer A | | Polymer A | | | | |
| Comparative | Low Tg | BA/AA | High Tg | MMA/BMA/DMAEMA | 70:30 | Epoxy crosslinking agent | 0.025 |
| Example 11 | Polymer A | | Polymer A | | | | |
| Example 13 | Low Tg | BA/AA | High Tg | MMA/BMA/DMAEMA | 70:30 | Metal coordination bond | 0.54 |
| | Polymer A | | Polymer A | | | crosslinking agent A | |
| Example 14 | Low Tg | BA/AA | High Tg | MMA/BMA/DMAEMA | 70:30 | Metal coordination bond | 0.36 |
| | Polymer A | | Polymer A | | | crosslinking agent A | |
| Example 15 | Low Tg | BA/AA | High Tg | MMA/BMA/DMAEMA | 70:30 | Metal coordination bond | 0.89 |
| | Polymer A | | Polymer A | | | crosslinking agent A | |
| Example 16 | Low Tg | BA/AA | High Tg | MMA/BMA/DMAEMA | 70:30 | Metal coordination bond | 1.10 |
| | Polymer A | | Polymer A | | | crosslinking agent A | |
| Example 17 | Low Tg | BA/AA | High Tg | MMA/BMA/DMAEMA | 70:30 | Metal coordination bond | 0.17 |
| | Polymer A | | Polymer A | | | crosslinking agent A | |
| Example 18 | Low Tg | BA/AA | High Tg | MMA/BMA/DMAEMA | 70:30 | Metal coordination bond | 0.21 |
| | Polymer A | | Polymer A | | | crosslinking agent B | |
| Example 19 | Low Tg | BA/AA | High Tg | MMA/BMA/DMAEMA | 70:30 | Metal coordination bond | 0.32 |
| | Polymer A | | Polymer A | | | crosslinking agent B | |

| | Adhesive strength test | | Heat shrinkage test | | | |
|---|---|---|---|---|---|---|
| | Initial | | Base | | Deformed | |
| | adhesive | Hot adhesive | material | Adhesive | portion | Dead |
| | strength | strength | exposed | exposed | length | air |
| | (N/25 mm) | (N/25 mm) | length (mm) | length (mm) | (mm) | space |
| Comparative | 31 | 13 | 1.1 | 1.1 | 2.3 | No |
| Example 1 | | | | | | |
| Example 1 | 7.2 | 14 | 0.06 | 0.29 | 1.2 | No |
| Example 2 | 6.1 | 17 | 0 | 0.37 | 1.1 | No |
| (with primer | | | | | | |
| layer) | | | | | | |
| Example 3 | 33 | 12 | 0.07 | 0.31 | 1.1 | No |
| Example 4 | 15 | 11 | 0.42 | 0.08 | 1.3 | No |
| Example 5 | 9.3 | 5.2 | 0.36 | 0.03 | 0.95 | No |
| Example 6 | 11 | 6.2 | 0.30 | 0 | 0.89 | No |
| Example 7 | 9.9 | 6.6 | 0.35 | 0 | 1.1 | No |
| Example 8 | 19 | 6.9 | 0 | 0.43 | 1.3 | No |
| Comparative | 44 | 7.4 | 0 | 7.6 | 7.6 | No |
| Example 2 | | | | | | |
| Comparative | 43 | 7.8 | 0 | 4.0 | 11 | No |
| Example 3 | | | | | | |
| Comparative | 42 | 7.0 | 0 | 5.4 | 16 | No |
| Example 4 | | | | | | |
| Comparative | 35 | 7.7 | 0.79 | 0.28 | 2.6 | No |
| Example 5 | | | | | | |
| Example 9 | 34 | 9.3 | 0.65 | 0 | 2.0 | No |
| Comparative | 0.3 | 0.1 | 0 | 12 | 50 | No |
| Example 6 | | | | | | |
| Comparative | 0.3 | 0.2 | 0 | 11 | 50 | No |
| Example 7 | | | | | | |
| Example 10 | 30 | 24 | 0.12 | 0.49 | 1.5 | No |
| Example 11 | 5.9 | 9.1 | 0.38 | 0 | 1.4 | No |
| Example 12 | 36 | 20 | 0.10 | 0.42 | 1.6 | No |
| Comparative | 45 | 9.5 | 0.91 | 0.91 | 2.2 | No |
| Example 8 | | | | | | |
| Comparative | 13 | 14 | 0.08 | 0.9 | 1.9 | Yes |
| Example 9 | | | | | | |
| Comparative | 22 | 19 | 0 | 1.0 | 2.8 | Yes |
| Example 10 | | | | | | |
| Comparative | 22 | 21 | 0 | 1.2 | 3.5 | Yes |
| Example 11 | | | | | | |
| Example 13 | 7.8 | 19 | 0 | 1.0 | 2.8 | No |
| Example 14 | 9.3 | 24 | 0 | 0.65 | 2.0 | No |
| Example 15 | 6.1 | 15 | 0.12 | 0.32 | 0.97 | No |
| Example 16 | 5.9 | 13 | 0.34 | 0.34 | 0.89 | No |
| Example 17 | 10 | 20 | 0 | 0.46 | 1.5 | No |
| Example 18 | 23 | 19 | 0 | 0.34 | 1.2 | No |
| Example 19 | 5.5 | 12 | 0.42 | 0.04 | 1.4 | No |

It will be apparent to those skilled in the art that various modifications can be made to the embodiments and the examples described above without departing from the basic principles of the present invention. In addition, it will be apparent to those skilled in the art that various improvements and modifications of the present invention can be carried out without departing from the spirit and the scope of the present invention.

### REFERENCE SIGNS LIST

1 Article
10 Heat-resistant shrinkable adhesive film
11 Adhesive layer
12 Substrate
20 Support member
21 Back surface portion
30 Vacuum heat crimping device
31 First vacuum chamber
32 Second vacuum chamber
33 Pedestal
34 Partition plate
35 Elevating table

What is claimed is:

1. A heat-resistant shrinkable adhesive film comprising (A) an acid functional group-containing (meth)acrylic polymer having a glass transition temperature of about 25° C. or lower, and (B) an acid or base functional group-containing (meth)acrylic polymer having a glass transition temperature of about 50° C. or higher, the mixing ratio of the component (A) being larger than the mixing ratio of the component (B), and the adhesive film comprising an adhesive layer with a crosslinked structure derived from a metal coordination bond crosslinking agent and can be stretched to an area magnification of 4 times or more.

2. The heat-resistant shrinkable adhesive film according to claim 1, wherein the deformed portion length after the heat shrinkage test is 2.0 mm or less.

3. The heat-resistant shrinkable adhesive film according to claim 1, wherein the mixing ratio of the components (A) and (B) is from 65:35 to 80:20 in terms of mass ratio.

4. The heat-resistant shrinkable adhesive film according to claim 1, wherein the component (A) is a copolymer of a monoethylenically unsaturated monomer and an unsaturated monomer containing a carboxyl group, and the component (B) is a copolymer of a monoethylenically unsaturated monomer and an unsaturated monomer containing an amino group.

5. The heat-resistant shrinkable adhesive film according to claim 4, wherein the monoethylenically unsaturated monomer is an alkyl (meth)acrylate having an alkyl group with 1 to 12 carbon atoms.

6. The heat-resistant shrinkable adhesive film according to claim 4, wherein the unsaturated monomer containing an amino group is at least one unsaturated monomer selected from dialkylaminoalkyl (meth)acrylate, dialkylaminoalkyl (meth)acrylamide, and an unsaturated monomer having a nitrogen-containing heterocycle.

7. The heat-resistant shrinkable adhesive film according to claim 1, wherein the metal coordination bond crosslinking agent is at least one selected from tris (2,4-pentanedionato) aluminum (III) and titanium diisopropoxybis (acetylsetonate).

8. The heat-resistant shrinkable adhesive film according to claim 1, which exhibits an initial adhesive force of 2.0 N/25 mm or more and a hot adhesive force of 2.0 N/25 mm or more.

9. The heat-resistant shrinkable adhesive film according to claim 1, which is used as a decorative film.

10. A method for producing an article, comprising a step of forming an article by vacuum heat-pressing the heat-resistant shrinkable adhesive film described in claim 1 on the surface of a support member, at least a part of the heat-resistant shrinkable adhesive film being stretched to an area magnification of 4 times or more.

11. An article in which the adhesive layer of the heat-resistant shrinkable adhesive film described in claim 1 is disposed on the surface of a support member, at least a part of the heat-resistant shrinkable adhesive film being stretched to an area magnification of 4 times or more.

12. A heat-resistant shrinkable adhesive composition comprising (A) an acid functional group-containing (meth)acrylic polymer having a glass transition temperature of about 25° C. or lower, and (B) an acid or base functional group-containing (meth)acrylic polymer having a glass transition temperature of about 50° C. or higher, and a metal coordination bond crosslinking agent, the mixing ratio of the component (A) being larger than the compounding ratio of the component (B).

13. The heat-resistant shrinkable adhesive composition according to claim 12, wherein the mixing ratio of the components (A) and (B) is from 65:35 to 80:20 in terms of mass ratio.

14. The heat-resistant shrinkable adhesive composition according to claim 12, which comprises 0.15 parts by mass or more of the metal coordination bond crosslinking agent based on a total of 100 parts by mass of the components (A) and (B).

15. The heat-resistant shrinkable adhesive composition according to claim 12, wherein the component (A) is a copolymer of a monoethylenically unsaturated monomer and an unsaturated monomer containing a carboxyl group, and the component (B) is a copolymer of a monoethylenically unsaturated monomer and an unsaturated monomer containing an amino group.

16. The heat-resistant shrinkable adhesive composition according to claim 15, wherein the monoethylenically unsaturated monomer is an alkyl (meth)acrylate having an alkyl group having 1 to 12 carbon atoms.

17. The heat-resistant shrinkable adhesive composition according to claim 15, wherein the unsaturated monomer containing an amino group is at least one unsaturated monomer selected from dialkylaminoalkyl (meth)acrylate, a dialkylaminoalkyl (meth)acrylamide, and an unsaturated monomer having a nitrogen-containing heterocycle.

18. The heat-resistant shrinkable adhesive composition according to claim 12, wherein the metal coordination bond crosslinking agent is at least one selected from tris (2,4-pentanedionato) aluminum (III) and titanium diisopropoxybis (acetylsetonate).
